(19) United States
(12) Patent Application Publication
(10) Pub. No.: US 2013/0039757 A1
(43) Pub. Date: Feb. 14, 2013

(54) HEAT DISSIPATING FAN HAVING A POROUS SINTERED BUSHING FOR AN IMPELLER SHAFT AND METHOD OF MAKING THE BUSHING

(71) Applicants: Chien-Jung CHEN, Kaohsiung City (TW); Hsin- Cheng SUN, Kaohsiung City (TW)

(72) Inventors: Chien-Jung CHEN, Kaohsiung City (TW); Hsin- Cheng SUN, Kaohsiung City (TW)

(73) Assignee: YEN SUN TECHNOLOGY CORP., Kaohsiung City (TW)

(21) Appl. No.: 13/208,066

(22) Filed: Aug. 11, 2011

(51) Int. Cl. F04D 29/05; B22F 3/16; B28B 3/00

(52) U.S. Cl. 415/229; 264/319; 264/109; 419/2

(57) ABSTRACT

A method of making a porous bushing for an impeller shaft of a heat dissipation fan, includes: compacting a porous body-forming material in a mold to form a green body that has a shape conforming to the porous bushing; and sintering the green body to form the porous bushing. A heat dissipating fan incorporating the porous bushing is also disclosed.

### BACKGROUND OF THE INVENTION

1. Field of the Invention

The invention relates to a heat dissipating fan, and more particularly to a bushing for an impeller shaft of a heat dissipating fan.

2. Description of the Related Art

Heat-dissipating fans are generally made from plastic materials in order to save costs and to facilitate fabrication processes thereof. Referring to FIG. 1, a conventional heat dissipation fan 1 includes a plastic bushing 11 molded integrally with a fan housing 12. A bearing 13 is disposed between the bushing 11 and a shaft 15 of an impeller 14. When the shaft 15 rotates, because frictional heat is generated between the bearing 13 and the shaft 15 and because the plastic bushing 11 has a relatively low heat conductivity and poor heat dissipating effect, the frictional heat tends to be accumulated within the bearing 13 resulting in degradation of the bearing 13 and shortening the service life of the heat dissipation fan.

In order to solve the aforesaid problem of poor heat dissipation, there is provided another conventional heat dissipation fan 2 having a metal bushing 21 as shown in FIG. 2. Because the metal bushing 21 has good heat dissipation, the service life of the bearing 23 can be prolonged. However, the metal bushing 21 has to be fabricated by machining, stamping, etc. During assembly of the heat dissipation fan 2, the metal bushing 21 is inserted into a bushing hole formed in a fan housing 22. For assembly, because a receiving space must be formed in the metal bushing 21 to receive the bearing 23 and because it is a troublesome task to obtain an accurate dimension for the receiving space of the metal bushing 21 by machining and/or stamping, the fabrication of the metal bushing 21 is inconvenient and costly.

### SUMMARY OF THE INVENTION

An object of the present invention is to provide a method of making a porous sintered bushing for a heat dissipating fan, which has high heat dissipating effect and which can be fabricated conveniently compared to the prior art shown in FIG. 2.

According to one aspect of the present invention, a method of forming a porous bushing for an impeller shaft of a heat dissipation fan comprises: compacting a porous body-forming material in a mold to form a green body that has a shape conforming to the porous bushing; and sintering the green body to form the porous bushing.

According to another aspect of the invention, a heat dissipating fan comprises a fan housing having a bushing hole, a bushing inserted into the bushing hole, and an impeller shaft inserted into the bushing. The bushing is a porous sintered body made by a method, which comprises: compacting a porous body-forming material in a mold to form a green body that has a shape conforming to the porous bushing; and sintering the green body to form the porous bushing.

### BRIEF DESCRIPTION OF THE DRAWINGS

Other features and advantages of the present invention will become apparent in the following detailed description of the preferred embodiment with reference to the accompanying drawings, of which:

FIG. 1 shows a heat dissipating fan including a conventional bushing for an impeller shaft;

FIG. 2 shows another heat dissipating fan including another conventional bushing for an impeller shaft;

FIG. 3 illustrates a molding tool used in a method according to a preferred embodiment of the present invention to form a green body for a bushing;

FIG. 4 is a perspective view of a bushing made by the method of the present invention;

FIG. 5 is an exploded view of a heat dissipating fan incorporating the bushing of FIG. 4; and

FIG. 6 is a sectional view illustrating that the bushing of FIG. 4 is assembled into a fan housing by insert molding.

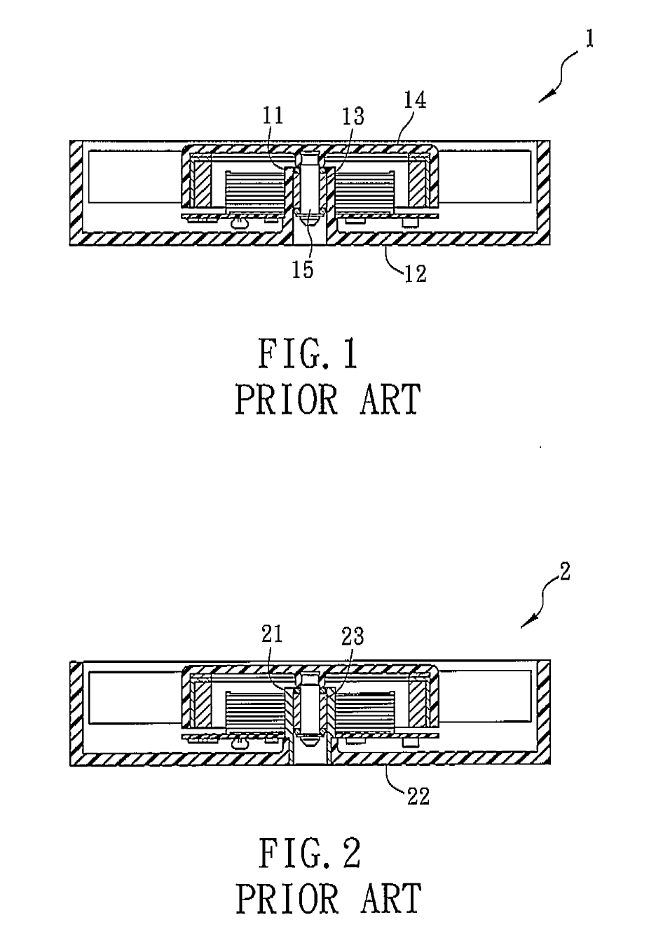

### DETAILED DESCRIPTION OF THE PREFERRED EMBODIMENT

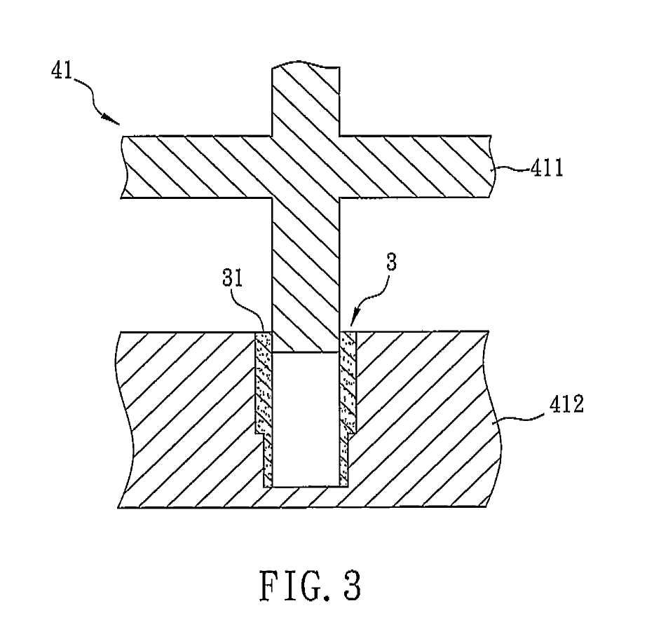

Referring to FIGS. 3 and 5, a preferred embodiment of the method of the present invention is employed to fabricate a bushing 32 for an impeller shaft 63 of a heat dissipation fan 6. The bushing 32 is to be assembled into a fan housing 61. The bushing 32 is fabricated by first forming a green body 31 from a porous body-forming material 3 in a molding tool 41. The molding tool 41 includes an upper mold 411 and a lower mold 412. The porous body-forming material 3 is filled in the lower mold 412 and is then compacted by applying high pressure to the upper mold 412 to press the porous body-forming material 3 against the lower mold 411. The green body 31 has a shape conforming to the bushing 32.

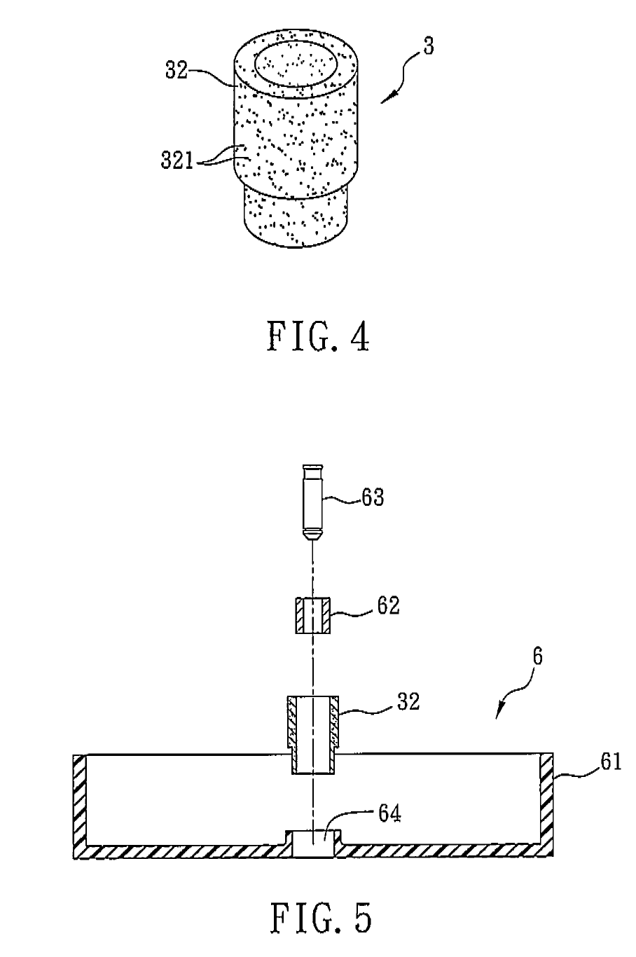

Referring to FIG. 4 in combination with FIG. 3, the green body 31 is formed into the porous bushing 32 having a plurality of pores 321 after being sintered in a sintering furnace (not shown). The green body 31 may be sintered by removing the green body 31 from the molding tool 41, following by placing the green body 31 in the sintering furnace, or by placing the green body 31 together with the molding tool 41 in the sintering furnace. The sintering furnace may be any conventional furnace suitable for sintering the green body 31, such as a high-temperature tunnel furnace, or a box-shaped furnace.

The porous body-forming material 3 may be a metal powder, a ceramic powder, or a mixture of the metal and ceramic powders. Particularly, the porous body-forming material 3 may be a powder material selected from the group consisting of copper (Cu), magnesium (Mg), iron (Fe), aluminum (Al), zinc (Zn), nickel (Ni), chromium (Cr), titanium (Ti), silver (Ag), silicon oxide (SiO₂), aluminum oxide (Al₂O₃), silicon carbide (SiC), zirconium boride (ZrB₂), and lanthanum boride (LaB₆), and a combination of two or more of the powder material. In a preferred embodiment, a copper powder having high thermal conductivity is used as the porous body-forming material 3. The bushing 32 can be provided with high thermal conductivity and excellent heat dissipating effect when being made from a metal powder. When a ceramic powder is used for the bushing 32, a relatively high hardness can be obtained for the bushing 32, and deformation of the bushing 32 can be avoided after a long period of use.

Preferably, a sintering temperature for sintering the green body 31 is lower than a melting point (MP) of the porous body-forming material 3. If the sintering temperature is higher than the melting point, the porous body-forming material will melt, and the amount of the pores 321 in the green body 31 will decrease. More preferably, the sintering temperature is 30%-95% of the melting point (MP) of the porous body-forming material 3. For example, the melting point (MP) of copper is about 1084° C., and the sintering temperature may range from 325.2° C. (30%) to 1029.8° C. (95%). In a preferred embodiment, the sintering temperature is 867.2° C. (80%). Suitable sintering temperatures for different powder materials are listed in Table I.

TABLE I

| Material | MP (100%) | 30% of MP. | 95% of MP | 80% of MP |
|---|---|---|---|---|
| Cu | 1084.0 | 325.2 | 1029.8 | 867.2 |
| Mg | 650.0 | 195.0 | 617.5 | 520.0 |
| Al | 660.0 | 198.0 | 627.0 | 528.0 |
| Fe | 1535.0 | 460.5 | 1458.3 | 1228.0 |
| Zn | 419.5 | 125.9 | 398.5 | 335.6 |
| Ni | 1455.0 | 436.5 | 1382.3 | 1164.0 |
| Cr | 1857.0 | 557.1 | 1764.2 | 1485.6 |
| Ti | 1668.0 | 500.4 | 1584.6 | 1334.4 |
| Ag | 962.0 | 288.6 | 913.9 | 769.6 |
| SiO₂ | 1650.0 | 495.0 | 1567.5 | 1320.0 |
| Al₂O₃ | 2054.0 | 616.2 | 1951.3 | 1643.2 |
| SiC | 2730.0 | 819.0 | 2593.5 | 2184.0 |
| ZrB₂ | 3000.0 | 900.0 | 2850.0 | 2400.0 |
| LaB₆ | 2100.0 | 630.0 | 1995.0 | 1680.0 |

The heat-dissipating effects and the mechanical strengths of the porous bushing 32 largely depend upon the number and size of the pores 321 formed in the bushing 32. The number and size of the pores 321 may be controlled based on the following factors:

(1) The magnitude of the pressure applied to the molding tool 41, which can vary the denseness of the green body 31;

(2) The amount of the porous body-forming material filled in the molding tool 41, which can also vary the denseness of the green body 31;

(3) The particle size of the porous body-forming material; and

(4) The sintering temperature of the green body 31.

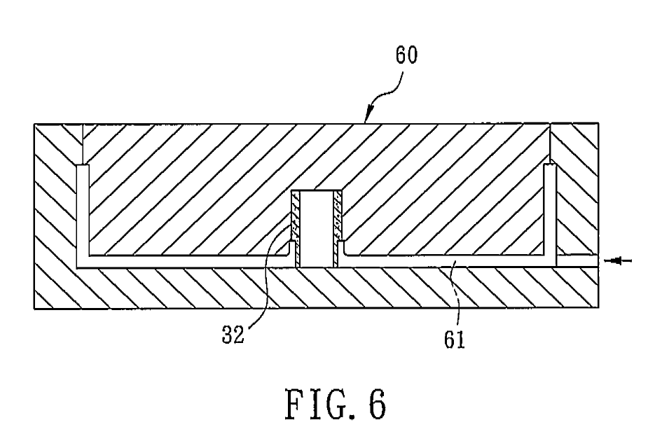

Referring back to FIG. 5, a bearing 62 is disposed between the impeller shaft 63 and the bushing 32. The bushing 32 and the fan housing 61 are formed separately and are assembled together by press fitting the bushing 32 into a preformed bushing hole 64 in the fan housing 61. Alternatively, the bushing 32 may be assembled into the fan housing 61 by insert molding. In particular, the fan housing 61 may be molded in a mold 60 as shown in FIG. 6 and the bushing 32 may be positioned to the mold 60 before a molding material of the fan housing 61 is introduced into the mold 60 so that the bushing 32 is fixed to the fan housing 61 after the fan housing 61 is formed in the mold 60.

According to the present invention, because the porous body-forming material 3 is used to fabricate the bushing 32, the bushing 32 has the pores 321 and the heat dissipating effect thereof is excellent. In addition, since the dimension of the bushing 32 can be precisely controlled using the molding tool 41, the method of the present invention can be conducted conveniently compared to the conventional machining and stamping processes for making the metal bushing 2 shown in FIG. 2. Thus, the costs of fabricating the bushing 32 according to the present invention can be relatively low.

While the present invention has been described in connection with what are considered the most practical and preferred embodiments, it is understood that this invention is not limited to the disclosed embodiment but is intended to cover various arrangements included within the spirit and scope of the broadest interpretation so as to encompass all such modifications and equivalent arrangements.

What is claimed is:

1. A method of forming a porous bushing for an impeller shaft of a heat dissipation fan, comprising:
compacting a porous body-forming material in a mold to form a green body that has a shape conforming to the porous bushing; and
sintering the green body to form the porous bushing.

2. The method of claim 1, wherein the porous body-forming material includes a powder selected from a group consisting of a metal powder and a ceramic powder.

3. The method of claim 1, wherein the porous body-forming material includes a powder selected from the group consisting of copper, magnesium, iron, aluminum, zinc, nickel, chromium, silver, silicon oxide, aluminum oxide, silicon carbide, zirconium boride, and lanthanum boride.

4. The method of claim 1, wherein the step of sintering is carried out at a sintering temperature lower than a melting point of the porous body-forming material.

5. The method of claim 4, wherein the sintering temperature is 30% to 95% of the melting point of the porous body-forming material.

6. The method of claim 4, wherein the sintering temperature is 80% of the melting point of the porous body-forming material.

7. A heat dissipating fan comprising:
a fan housing having a bushing hole;
a bushing inserted into said bushing hole; and
an impeller shaft inserted into said bushing,
wherein said bushing is a porous sintered body made by a method, which comprises:
compacting a porous body-forming material in a mold to form a green body that has a shape conforming to the porous bushing; and
sintering the green body to form the porous bushing.

8. The heat dissipating fan of claim 7, wherein the porous body-forming material includes a powder selected from a group consisting of a metal powder and a ceramic powder.

9. The heat dissipating fan of claim 7, wherein the porous body-forming material includes a powder material selected from the group consisting of copper, magnesium, iron, aluminum, zinc, nickel, chromium, silver, silicon oxide, aluminum oxide, silicon carbide, zirconium boride, and lanthanum boride.

10. The heat dissipating fan of claim 7, wherein the sintering is carried out at a sintering temperature lower than a melting point of the porous body-forming material.

11. The heat dissipating fan of claim 10, wherein the sintering temperature is 30% to 95% of the melting point of the porous body-forming material.
